(19) United States
(12) Patent Application Publication
(10) Pub. No.: US 2007/0036126 A1
(43) Pub. Date: Feb. 15, 2007

(54) Laser position measurement system

(76) Inventor: David K. Poole, Boise, ID (US)

Correspondence Address: AVAGO TECHNOLOGIES, LTD., P.O. BOX 1920, DENVER, CO, 80201-1920, US

(21) Appl. No.: 11/199,876

(22) Filed: Aug. 8, 2005

(51) Int. Cl. H04J 3/06

(52) U.S. Cl. 370/350

(57) ABSTRACT

A system having a laser position measurement system is provided including providing a system, such as an imaging system, attaching a light source and a receiver, and connecting electronic circuits to the receiver for position information.

### BACKGROUND ART

The present invention relates generally to optical systems, and more particularly to a system with position measurement, such as an imaging system.

A scanner produces a digital representation of an original item. A variety of originals may be scanned, including documents, photographs, transparencies, or three-dimensional objects. The scanner maps locations on the original to memory locations, usually in a computer file.

The scanner typically sweeps a scanning mechanism near the original. The mechanism may contain a light source for illuminating the original, optical components for creating an image of the original, and sensors for converting the image to electronic signals. The scanning mechanism is typically actuated by a drive system that may include a motor, gears, belts, pulleys, cables, or other components.

Most often, one of two motor types is used. Many scanners use a stepper motor. A stepper motor moves its shaft angularly in response to the magnitudes and directions of currents in two or more winding phases. As the winding currents are changed, the motor shaft moves to different equilibrium positions. Stepper motors are often driven “open loop”. That is, no measuring device is used to provide feedback as to the motor shaft position. As long as the motor is driven within its operating envelope, it can be counted on to move its shaft, and consequently the scanning mechanism, to the commanded positions.

Stepper motors provide fine control of the scanning mechanism position, especially when reduction gears are used in the drive system, and thus can allow construction of scanners with very high resolutions. However, stepper motors often have a limited speed range over which they can operate. Using reduction gears to increase the scanning resolution further reduces the speed at which the scanner can operate with a given stepper motor.

Some scanners use a DC motor drive. A DC motor provides a torque in proportion to the current in its winding. It has no inherent positioning means, so an external position-measuring device is used, often an optical encoder. A controller, such as a microprocessor, reads the motor or scan mechanism position and adjusts the motor winding current in such a way as to cause the scan mechanism to sweep through a series of desired positions at the proper times. DC motors may operate at substantial speeds, but the available encoders often cannot provide the resolution attainable with a stepper motor and reduction gears.

Speed and resolution are two important components of scanner performance. Both high speed and high resolution are desired, but these are often competing goals. It is desirable that a scanner be able to scan at high resolution when required and scan at high speed when required. Each motor type has a disadvantage in either speed or resolution.

Thus a need still remains for a motion control system that can both provide high resolution and scan at high speed. In view of the ever-increasing need to improve speed and improve resolution, it is more and more critical that answers be found to these problems.

Solutions to these problems have been long sought but prior developments have not taught or suggested any solutions and, thus, solutions to these problems have long eluded those skilled in the art.

### SUMMARY OF THE INVENTION

The present invention provides a system having a laser position measurement system including providing a system, such as an imaging system, attaching a light source and a receiver to the system, and connecting electronic circuits to the receiver for position information.

Certain embodiments of the invention have other aspects in addition to or in place of those mentioned or obvious from the above. The aspects will become apparent to those skilled in the art from a reading of the following detailed description when taken with reference to the accompanying drawings.

### BRIEF DESCRIPTION OF THE DRAWINGS

FIG. 1 is a top view of a fixed image-source imaging system having a laser position measurement system in an embodiment of the present invention;

FIG. 2 is a top view of an image-source feed imaging system having a laser position measurement system in an alternative embodiment of the present invention;

FIG. 3 is a top view of a hard copy system having a laser position measurement system in another alternative embodiment of the present invention; and

FIG. 4 is a flow chart of a system having a laser position measurement system in an embodiment of the present invention.

### DETAILED DESCRIPTION OF THE INVENTION

In the following description, numerous specific details are given to provide a thorough understanding of the invention. However, it will be apparent that the invention may be practiced without these specific details. In order to avoid obscuring the present invention, some well-known circuits, protection configurations, and process steps are not disclosed in detail.

Likewise, the drawings showing embodiments of the apparatus/device are semi-diagrammatic and not to scale and, particularly, some of the dimensions are for the clarity of presentation and are shown greatly exaggerated in the drawing FIGs. Similarly, although the sectional views in the drawings for ease of description show the actuators as oriented vertically, this arrangement in the FIGs. is arbitrary and is not intended to suggest that the actuators should necessarily be fabricated in a vertical direction. Generally, the device can be operated in any orientation. The same numbers are used in all the drawing FIGs. to relate to the same elements.

The term “horizontal” as used herein is defined as a plane parallel to the conventional plane or surface of the invention, regardless of its orientation. The term “vertical” refers to a direction perpendicular to the horizontal as just defined. Terms, such as “on”, “above”, “below”, “bottom”, “top”, “side” (as in “sidewall”), “higher”, “lower”, “upper”, “over”, and “under”, are defined with respect to the horizontal plane.

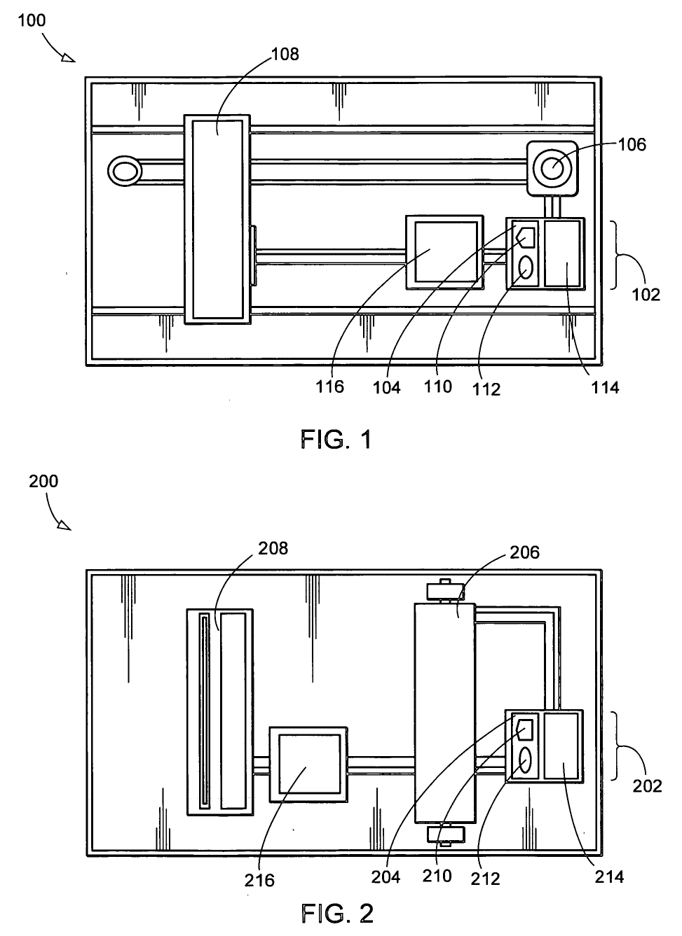

Referring now to FIG. 1, therein is shown a top view of a fixed image-source imaging system 100 having a laser position measurement system 102 in an embodiment of the present invention. The laser position measurement system 102 includes a laser sensor 104 mounted in the fixed image-source imaging system 100. The laser sensor 104 provides movement and position information.

The movement and position information is used to control a motor 106, such as a DC motor without the need for a stepping function. The motor 106 provides movement and positioning of an imaging apparatus 108 that moves across the fixed image-source imaging system 100 so as to convert a visual image contained on an image-source (not shown) into an electronic signal image that is usable by electronic devices such as data processing machines and hard copy production.

For the fixed image-source imaging system 100, such as a flatbed scanner, the scanning process is accomplished by moving the imaging apparatus 108 including a scanning light source (not shown) and a scanning reflector (not shown). The motor 106 is mechanically connected to the imaging apparatus 108 to move the imaging apparatus 108 along the length of the image-source. The light reflected from the image-source is captured wherein a maximum amount of light is typically reflected from light areas of the image-source and a minimum amount of light is typically reflected from the dark areas of the image-source. The visual image of the image-source is stored or processed as an electronic signal image.

The laser sensor 104 controls the motor 106 providing movement and positioning of the imaging apparatus 108. The laser sensor 104 receives movement and position information from a laser source 110 and a laser receptor 112. The laser source 110, such as a laser diode, and the laser receptor 112, such as a photo detector, are mounted in the fixed image-source imaging system 100. The laser source 110 and the laser receptor 112 provide data to a controller 114 having electronic circuits. The controller 114 processes the data and interfaces with the motor 106 and an image processing circuit 116 of the fixed image-source imaging system 100.

The laser source 110 emits electromagnetic pulses in a visible range. The reflected pulses from the beam are received into the laser receptor 112. The controller 114, such as pulse and sample timing circuitry, is connected to the laser source 110 and the laser receptor 112. The laser sensor 104 is positioned at a first location and illuminates a second location, such as a reflector or the laser receptor 112. A beam of electromagnetic pulses illuminates the second location. The laser sensor 104 measures the round trip time of the pulses. The second location need not be in a place perpendicular to the beam, so long as sufficient light is provided to the laser receptor 112.

For illustrative purposes, the laser source 110 and the laser receptor 112 are shown together as the laser sensor 104 attached to the fixed image-source imaging system 100, although it is understood that the laser source 110 and the laser receptor 112 may be separate, as well. Further the laser source 110 may be mounted in the fixed image-source imaging system 100 and the laser receptor 112 may be attached to the imaging apparatus 108. Yet further the laser source 110 may be attached to the imaging apparatus 108 and the laser receptor 112 may be mounted in the fixed image-source imaging system 100.

Movement properties, such as direction and speed, are adjustable and adapted to the imaging apparatus 108 and the image processing circuit 116. The image processing circuit 116 controls quality and speed of the fixed image-source imaging system 100 through the controller 114, the motor 106 and the imaging apparatus 108 using data from the laser sensor 104.

The laser sensor 104 also provides feedback to the image processing circuit 116 for adjustments and adaptations to insure that the controller 114 compensates for shifts in movement or positioning necessary to maintain the desired scanning speed. The speed of the fixed image-source imaging system 100 is adjusted while maintaining the sampling rate constant to produce uniform scaling. The actual pixel density and, as a result, the resolution of the scanned image is controlled. The laser sensor 104 provides rapid and accurate movement and positioning information. The rapid and accurate feedback to the controller 114 and the image processing circuit 116 provides optimized scanning speed and resolution of the scanned image.

Referring now to FIG. 2, therein is shown a top view of an image-source feed imaging system 200 having a laser position measurement system 202 in an alternative embodiment of the present invention. The laser position measurement system 202 includes a laser sensor 204 mounted in the image-source feed imaging system 200. The laser sensor 204 provides movement and position information.

The movement and position information is used to control a motor 206, such as a DC motor without the need for a stepping function. The motor 206 provides movement and positioning of an image-source (not shown) that moves across the image-source feed imaging system 200, so as to convert a visual image contained on the image-source into an electronic signal image that is usable by electronic devices such as data processing machines and hard copy production.

For the image-source feed imaging system 200, such as an automatic feed scanner, the scanning process is accomplished by moving the image-source. The motor 206 moves the image-source over an imaging apparatus 208 that is in a substantially fixed location. In a manner similar to the fixed image-source imaging system 100 as shown in FIG. 1, the light reflected from the image-source is captured wherein a maximum amount of light is typically reflected from light areas of the image-source and a minimum amount of light is typically reflected from the dark areas of the image-source. The visual image of the image-source is stored or processed as an electronic signal image.

In a manner similar to the laser sensor 104 of the fixed image-source imaging system 100 as shown in FIG. 1, the laser sensor 204 controls the motor 206 providing movement and positioning of the imaging apparatus 208. The laser sensor 204 receives movement and position information from a laser source 210 and a laser receptor 212. The laser source 210, such as a laser diode, and the laser receptor 212, such as a photo detector, are mounted in the image-source feed imaging system 200. The laser receptor 212 provides data to a controller 214. The controller 214 processes the data and interfaces with the motor 206 and an image processing circuit 216 of the image-source feed imaging system 200.

The laser source 210 emits electromagnetic pulses in a visible range. The reflected pulses from the beam are received into the laser receptor 212. The controller 214, such as pulse and sample timing circuitry, is connected to the laser source 210 and the laser receptor 212. The laser sensor 204 is positioned at a first location and illuminates a second location, such as a reflector. A beam of electromagnetic pulses illuminates the second location. The laser sensor 204 measures the round trip time of the pulses. The second location need not be in a place perpendicular to the beam, so long as sufficient light is provided to the laser receptor 212.

For illustrative purposes, the laser source 210 and the laser receptor 212 are shown together as the laser sensor 204 attached to the image-source feed imaging system 200, although it is understood that the laser source 210 and the laser receptor 212 may be separate, as well.

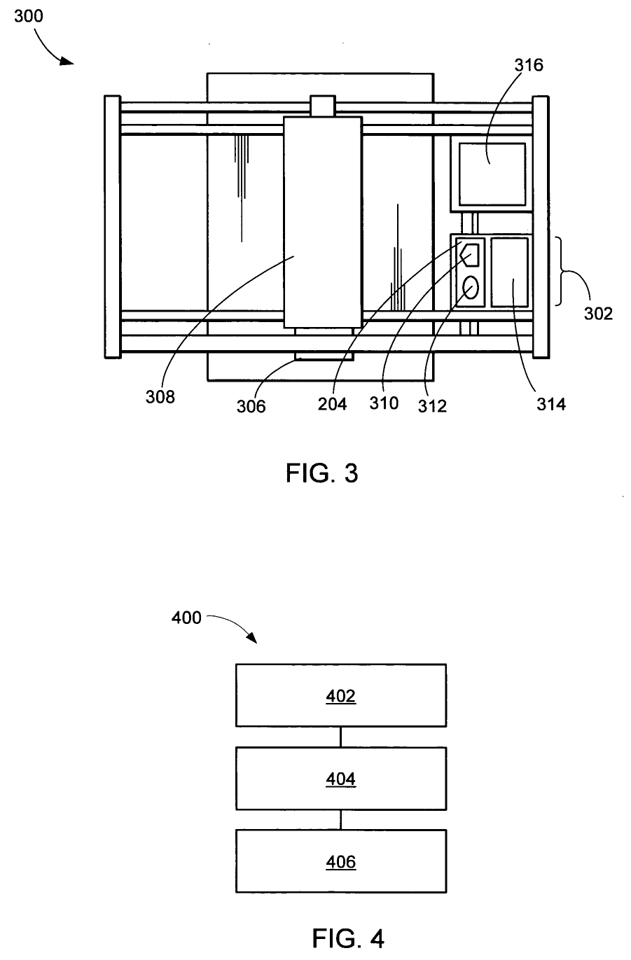

Referring now to FIG. 3, therein is shown a top view of a hard copy system 300 having a laser position measurement system 302 in another alternative embodiment of the present invention. The laser position measurement system 302 includes a laser sensor 304 mounted in the hard copy system 300. The laser sensor 304 provides movement and position information.

The movement and position information is used to control a motor 306, such as a DC motor without the need for a stepping function. The motor 306 provides movement and positioning of an imaging apparatus 308 that moves across the hard copy system 300 so as to convert an electronic signal image that is usable by electronic devices to a visual image on a hard copy medium (not shown).

For the hard copy system 300, such as a printer, the imaging process is accomplished by moving the imaging apparatus 308 including an imaging head (not shown) and a pigment supply (not shown). The motor 306 is mechanically connected to the imaging apparatus 308 to move the imaging apparatus 308 across the width of the print medium. The printing head deposits pigments (not shown) as the imaging apparatus 308 is moved across the printing medium. The visual image of the electronic signal image is printed on the print medium.

In a manner similar to the laser sensor 104 of the fixed image-source imaging system 100 as shown in FIG. 1 and the laser sensor 204 of the image-source feed imaging system 200 as shown in FIG. 2, the laser sensor 304 controls the motor 306 providing movement and positioning of the imaging apparatus 308. The laser sensor 304 receives movement and position information from a laser source 310 and a laser receptor 312. The laser source 310, such as a laser diode, and the laser receptor 312, such as a photo detector, are mounted in the hard copy system 300. The laser receptor 312 provides data to a controller 314. The controller 314 processes the data and interfaces with the motor 306 and an image processing circuit 316 of the hard copy system 300.

The laser source 310 emits electromagnetic pulses in a visible range. The reflected pulses from the beam are received into the laser receptor 312. The controller 314, such as pulse and sample timing circuitry, is connected to the laser source 310 and the laser receptor 312. The laser sensor 304 is positioned at a first location and illuminates a second location, such as a reflector or the laser receptor 312. A beam of electromagnetic pulses illuminates the second location. The laser sensor 304 measures the round trip time of the pulses. The second location need not be in a place perpendicular to the beam, so long as sufficient light is provided to the laser receptor 312.

For illustrative purposes, the laser source 310 and the laser receptor 312 are shown together as the laser sensor 304 attached to the hard copy system 300, although it is understood that the laser source 310 and the laser receptor 312 may be separate, as well. Further the laser source 310 may be mounted in the hard copy system 300 and the laser receptor 312 may be attached to the imaging apparatus 308. Yet further the laser source 310 may be attached to the imaging apparatus 308 and the laser receptor 312 may be mounted in the hard copy system 300.

Referring now to FIG. 4, therein is shown a flow chart of a system 400 having a laser position measurement system 402 in an embodiment of the present invention. The system 400 includes a system, such as an imaging system, in a block 402; attaching a light source and a receiver to the system in a block 404; and connecting circuitry to the receiver for position information in a block 406.

It will be understood that the flow chart is merely exemplary and many other steps may be added and some removed as would be evident to those having ordinary skill in the art from a reading of the above disclosure.

In greater detail, a method to fabricate system with the laser position measurement system 102, in an embodiment of the present invention, is performed as follows:
1. The laser position measurement system 102 is attached to a system, such as a scanner system or a printer system. (FIG. 1)
2. The laser sensor 104 having the laser source 110 such as a laser diode, and the laser receptor 112, such as a photo detector, is attached to the system 100, the laser sensor measuring the position of the imaging apparatus 108. (FIG. 1)
3. The controller 114 is connected to the laser sensor 104 to process position information. (FIG. 1)

It has been discovered that the present invention thus has numerous aspects.

An aspect of the present invention provides improved resolution for systems such as scanners and printers. The improved resolution is a direct result of the precise motion controls of the motor. This precise motion control of the motor may provide further precision to the imaging apparatus motion and image capture.

It has been discovered that the disclosed structure provides a reduction in cost. The motion control provides precise control of lower cost DC motors. Significantly more expensive stepper motors are no longer required to provide the precision motion. More significant reductions in cost are provided to systems previously requiring both DC and stepper motors

It has also been discovered that the disclosed structure provides an increase in reliability. The use of DC motors provides an increase in reliability compared to stepper motors. DC motors have several reliability advantages, such as simpler mechanical construction and higher output. The disclosed structure also provides controllers having an increase in reliability compared to stepper motor controllers.

Yet another discovery of the disclosed structure is an improvement in speed. Higher speeds are attainable with DC motors compared to stepper motors. The higher speeds and precise motion control provide increased overall speed. The controller may provide additional or variable speed control providing additional increases in overall speed.

These and other valuable aspects of the present invention consequently further the state of the technology to at least the next level.

Thus, it has been discovered that the laser position measurement system method and apparatus of the present invention furnish important and heretofore unknown and unavailable solutions, capabilities, and functional aspects for protection systems. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations, which fall within the scope of the included claims. All matters hithertofore set forth herein or shown in the accompanying drawings are to be interpreted in an illustrative and non-limiting sense.

The invention claimed is:

1. A system having a laser position measurement system comprising:
providing a system, such as an imaging system;
attaching a light source and a receiver to the system; and
connecting electronic circuits to the light source and the receiver to detect light transmissions from the light source for calculating position information.

2. The system as claimed in claim 1 wherein attaching the light source and the receiver further comprises mounting the light source in the system and attaching the receiver to an imaging apparatus.

3. The system as claimed in claim 1 wherein connecting the electronic circuits to the light source and the receiver further comprises connecting control circuits to the light source and the receiver for controlling the movement and position of a motor.

4. The system as claimed in claim 1 wherein providing the system further comprises providing a fixed image-source imaging system, such as a flatbed scanner, having an image-source which is substantially fixed and a moving imaging apparatus.

5. The system as claimed in claim 1 wherein providing the system further comprises providing a an image-source feed imaging system, such as a automatic feed scanner, having an imaging apparatus which is substantially fixed and a moving image-source.

6. A system having a laser position measurement system comprising:
providing a system, such as a scanner system or a printer system;
attaching a laser sensor having a laser diode and a photo detector, to the system, the laser sensor measuring the position of an imaging apparatus; and
connecting a controller to the laser sensor to process position information.

7. The system as claimed in claim 6 further comprising connecting a DC motor to an imaging apparatus, the DC motor providing movement and positioning of the imaging apparatus.

8. The system as claimed in claim 6 further comprising attaching a reflector to an imaging apparatus, such as a scanning or a printing apparatus, the reflector reflecting light from the laser diode to the photo detector.

9. The system as claimed in claim 6 wherein attaching the laser sensor further comprises attaching the photo detector to an imaging apparatus and mounting the laser diode in the system partially within a line of sight of the photo detector.

10. The system as claimed in claim 6 wherein connecting the controller further comprises connecting electronic circuits providing control of movement and positioning of an imaging apparatus.

11. A system having a laser position measurement system comprising:
a system, such as an imaging system, having a light source and a receiver attached to the system, and electronic circuits connected to the light source and the receiver to detect light transmission from the light source for calculating position information.

12. The system as claimed in claim 11 wherein the light source and the receiver further comprises the light source mounted in the system and the receiver attached to an imaging apparatus.

13. The system as claimed in claim 11 wherein the electronic circuits connected to the light source and the receiver further comprises control circuits connected to the light source and the receiver for controlling movement and position of a motor.

14. The system as claimed in claim 11 wherein the system further comprises a fixed image-source imaging system, such as a flatbed scanner, having an image-source which is substantially fixed and a moving imaging apparatus.

15. The system as claimed in claim 11 wherein the system further comprises an image-source feed imaging system, such as an automatic feed scanner, having an imaging apparatus which is substantially fixed and a moving image-source.

16. The system as claimed in claim 11 wherein the light source and the receiver further comprise a laser sensor having a laser diode and a photo detector, the laser sensor measuring the position of an imaging apparatus.

17. The system as claimed in claim 11 further comprising a DC motor connected to an imaging apparatus, the DC motor providing movement and positioning of the imaging apparatus.

18. The system as claimed in claim 11 further comprising a reflector attached to an imaging apparatus, such as a scanning or a printing apparatus, the reflector reflecting light from the laser diode to the photo detector.

19. The system as claimed in claim 11 wherein the light source and the receiver further comprise a laser sensor having a photo detector attached to an imaging apparatus and a laser diode mounted in the system partially within a line of sight of the photo detector.

20. The system as claimed in claim 11 wherein the electronic circuits further comprise a controller providing control of movement and positioning of an imaging apparatus.
